(19) United States
(12) Patent Application Publication
(10) Pub. No.: US 2012/0175177 A1
(43) Pub. Date: Jul. 12, 2012

(54) Vehicle Battery Pack Frame

(75) Inventors: Chunhui Kevin Lee, Troy, MI (US); Peyman Aghssa, Ann Arbor, MI (US); Matthew B. Makowski, Northville, MI (US); Steve Siu, Bloomfield, MI (US); Patrick Daniel Maguire, Ann Arbor, MI (US); Eric Schwartz, Farmington Hills, MI (US)

(73) Assignee: Ford Global Technologies LLC

(21) Appl. No.: 13/075,280

(22) Filed: Mar. 30, 2011

Related U.S. Application Data
(60) Provisional application No. 61/430,955, filed on Jan. 7, 2011.

(51) Int. Cl. B60R 16/04; B23P 11/00; B21D 53/88

(52) U.S. Cl. 180/68.5; 29/897.2; 29/428

(57) ABSTRACT

The present disclosure relates to a battery assembly for a vehicle, including a battery module having a plurality of battery cells, and a frame configured to reinforce the battery module, the frame having an upper section and a lower section of different size or shape.

### CROSS-REFERENCE TO RELATED APPLICATIONS

This application is a continuation and claims the benefit of U.S. Provisional Patent Application Ser. No. 61/430955 titled “Vehicle Battery Pack Frame” filed Jan. 7, 2011, which is hereby incorporated by reference in its entirety.

### TECHNICAL FIELD

The present disclosure relates to vehicle battery assemblies and frames, particularly for electric, hybrid electric, and/or fuel cell vehicles.

### BACKGROUND

More modern vehicles are relying on electric power for the vehicle's primary power source or fuel. Existing electrically powered vehicles include hybrid electric vehicles, electric vehicles and fuel cell vehicles. In order to maximize the vehicle's effective driving range, it is desirable to increase the number of battery cells the vehicle carries. The battery cells are typically separated into modules and installed in a location within the vehicle. Existing storage locations for batteries include, the fuel tank zone, tunnel area (or underbody), underneath the seats, or in the trunk area. In addition, the packaging of battery modules can require particular attention with respect to impact energy management and mitigation.

Therefore, it is desirable to optimize the number of battery modules in a vehicle while minimizing the overall packaging space required for the battery pack. It is also desirable to incorporate enhanced impact mitigation techniques into the battery assembly.

### SUMMARY

The present invention may address one or more of the above-mentioned issues. Other features and/or advantages may become apparent from the description which follows.

Certain embodiments of the present invention relate to a battery assembly for a vehicle, including: a plurality of battery cells arranged in sections; a frame configured to house at least some of the battery cells; and a frame reinforcement unit securable to the frame.

Another embodiment of the present invention relates to an electrically powered vehicle, having: a battery assembly, including: a frame, housing at least some battery cells arranged in sections; and a frame reinforcement unit securable to the frame.

Another embodiment of the present invention relates to a method of manufacturing a battery pack within a vehicle, the method including: separating a plurality of cells within the module into a first section of cells and a second section of cells, the sections having different configurations; forming a frame configured to house at least some of the battery cells; and securing a frame reinforcement unit to the frame.

One advantage of the present disclosure is that it teaches a framing structure with a unique design that creates a skeleton structure for the entire battery pack. The design creates a reinforcement cage around the battery cells protecting them in the event of impact.

Another advantage of the present disclosure is that it teaches a design that maximizes the usage of vehicle trunk space. The structure is an engineered angle iron frame that houses the battery pack and protects it not only from impact but also resists shearing, bending, and twisting. The battery pack assembly also reduces system noise and vibration. The framing structure can be attached to the panels of the battery casing yielding relatively strong shear panels.

Another benefit of the present disclosure is that it teaches a framing structure that can sealing off the battery pack from environmental contaminants, such as water, dirt or debris.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same reference numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a side view of a vehicle with an exemplary vehicle after a rear impact situation.

FIG. 2 is a perspective view of the rear section of the vehicle of FIG. 1 with an exemplary battery pack assembly.

FIG. 3 is a perspective view of the rear section of the vehicle of FIG. 1.

FIG. 4 is a side view of the rear section of the vehicle of FIG. 1.

FIG. 5 is a rear perspective view of the battery pack frame of FIG. 2.

FIG. 6 is another rear perspective view of the battery pack frame of FIG. 5 with battery modules removed.

FIG. 7 is a front perspective view of the frame reinforcement unit of FIG. 2.

FIG. 8 is an exploded view of the frame reinforcement unit of FIG. 7.

FIG. 9 is a perspective view of a rear section of a vehicle compatible with another exemplary vehicle battery pack assembly.

FIG. 10 is a perspective view of a reinforcement bracket for use with the battery pack assembly of FIG. 9.

FIG. 11 is an assembly view of a vehicle floor pan, reinforcement bracket and battery pack assembly of FIG. 9.

FIG. 12 is a perspective view of the vehicle battery pack assembly of FIG. 9 incorporated into the vehicle.

FIG. 13 is a perspective view of the rear section of the vehicle shown in FIG. 12.

FIG. 14 is a side view of a vehicle chassis with another exemplary vehicle battery pack frame.

FIG. 15 is the battery pack frame of FIG. 14.

FIG. 16 is a side view of a vehicle chassis with another exemplary vehicle battery pack frame.

FIG. 17 is the battery pack frame of FIG. 16.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION

Referring to the drawings, wherein like characters represent the same or corresponding parts throughout the several views there are shown exemplary vehicle battery packs with frames and reinforcement units. The exemplary designs relate to framing configurations for vehicle battery pack assemblies that can be installed in a cargo area of the vehicle (e.g., the trunk). The frames provide structural support to the battery pack and mitigate deformation and/or intrusion upon impact. In one embodiment, the frame acts as a steel cage configured to mitigate crash energy. The frame is an engineered angle iron frame.

In another embodiment, the frame is T-shaped. The T-shaped battery pack design utilizes packaging space above and below a vehicle load floor in order to maximize usable storage space for vehicle users. The illustrated reinforcement units include shear panels attachable to the frame that provide further structural support to the battery pack. Shear panels also cover the internal components of the battery pack thus protect battery cells from environmental contaminants.

The illustrated battery packs are demonstrative of battery modules or assemblies used in hybrid, electric or fuel cell vehicle. The term “battery” includes any device that disseminates stored electric energy, e.g., from a chemical reaction. Batteries can be for example, Li-ion, NiMH, Ni-polymer, Pb-acid, cadmium based, alkaline, fuel cells or any other type of fuel source. Vehicle battery packs and frames are compatible with any type of vehicle including coupes, sedans, hatchbacks, SUVs, all utility vehicles, trucks and vans. Though the illustrated examples pertain to battery packs stored in a rear cargo section of the vehicle, the battery packs can be located in any area of the vehicle including underneath the hood or floor pan.

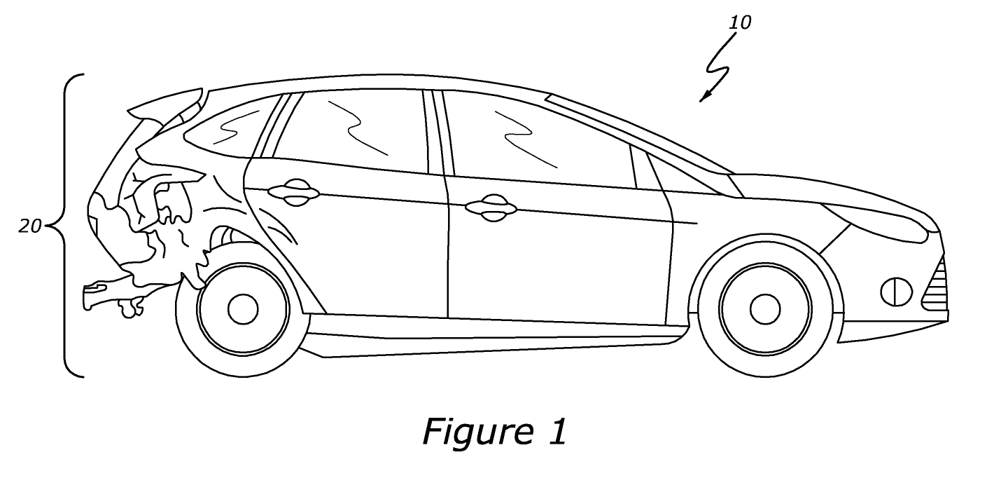

Referring now to FIG. 1, there is shown therein a side view of a vehicle 10 compatible with an exemplary vehicle battery pack. The vehicle 10 has been impacted in a rear section of the vehicle 20, which is deformed. The vehicle 10 shown is a four-door hatchback. The vehicle 10 is an electric vehicle, having a battery pack stored in the rear section of the vehicle 20.

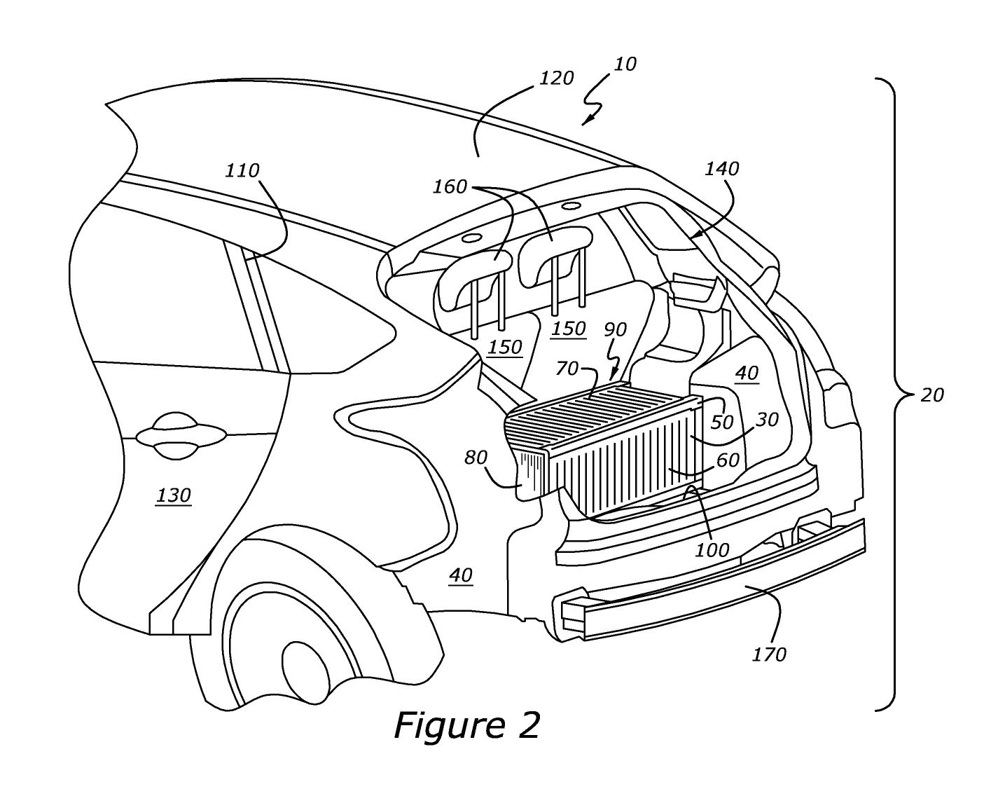

FIG. 2 is a perspective view of the rear section of the vehicle 20 shown in FIG. 1. The vehicle 10 is shown pre-impact. A battery pack 30 is stored in the rear section of the vehicle 20. The battery pack 30 is situated between two rear wheel hubs formed in the vehicle body side panels 40. The battery pack 30 includes a frame 50 that is partially covered by shear resistant side panels (e.g., 60, 70 and 80). In this embodiment, panels 60, 70 and 80 are composed of a sheet metal, e.g., aluminum composite. In other embodiments, the shear resistant panels 60, 70 and 80 are composed of steel, titanium or plastic.

An upper section 90 of the battery pack 30 is shown in FIG. 2. The upper section 90 of the pack sits above a vehicle floor pan 100. A lower section of the pack (e.g., 220 as discussed with respect to FIG. 4) sits below the floor pan 100.

The vehicle 10, as partially shown in FIG. 2, includes a C-pillar 110 and roof 120. Adjacent the C-pillar 110 is a closed passenger door 130. The rear section of the vehicle 20 has a cargo area 140. The rear door is removed. The cargo area 140 of the vehicle is adjacent a rear row of seating 150. Headrests 160 on the row of seats are shown extended. A bumper 170 is attached to the vehicle frame and configured to absorb rear impact energy as well.

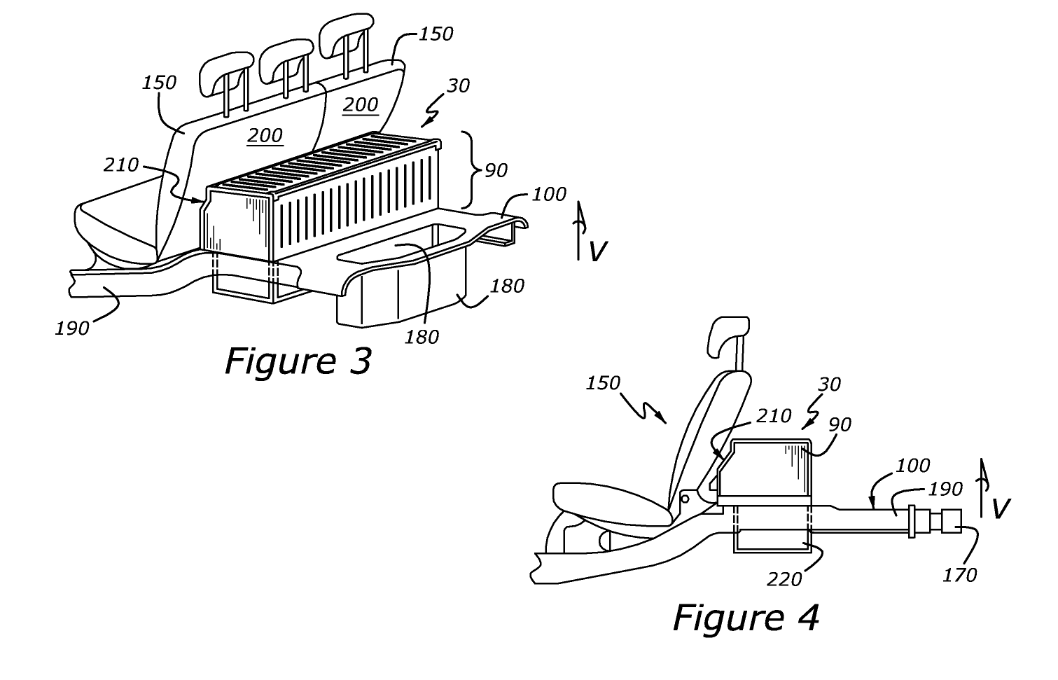

Referring now to FIG. 3, which is a perspective view of the vehicle of FIG. 2 with body panels and C-pillar removed, the upper section of the battery pack 90 is partially shown. The pack 30 is attached to the floor pan 100. Defined in the floor pan 100 is a storage well 180. Items such as a vehicle spare tire, tire repair systems and jumper cables can be stored in this space. The row of rear seats 150 are attached to a main vehicle frame rail 190. The upper section of the battery pack 90 is positioned just behind the lumbar support 200 for the seats 150. A front section of the battery pack 30 is contoured at 210—i.e., bent at a 20 degree angle with respect to a vertical axis of the vehicle, V—to complement the maximum reclined position of the seating lumbar support 200. In this embodiment, the rear seats 150 are configured to recline 20 degrees with respect to the vertical axis, V. In other embodiments, the frame contour and/or lumbar support can be designed to contour and recline at greater or lesser angles.

FIG. 4 is a side view of the rear seating 150 and battery pack 30 of FIGS. 2 and 3. As shown in FIG. 4, the front section of the battery pack 30 is contoured or angled to complement the lumbar support for the rear seating at 210. Seats 150 are configured to rest or recline at an angle of approximately 20 degrees with respect to the vertical axis of the vehicle. Rail is also bent to an angle of 20 degrees with respect to the vertical axis of the vehicle, V.

As shown in FIG. 4, battery pack 30 includes the upper section 90 which is positioned above the floor pan 100 and vehicle main frame rail 190; and the lower section 220 which is positioned beneath the floor pan 100 and vehicle main frame rail 190. The lower section extends through rail 190. In this embodiment, the bottom section of the lower section of the battery pack 30 is covered by shear panels.

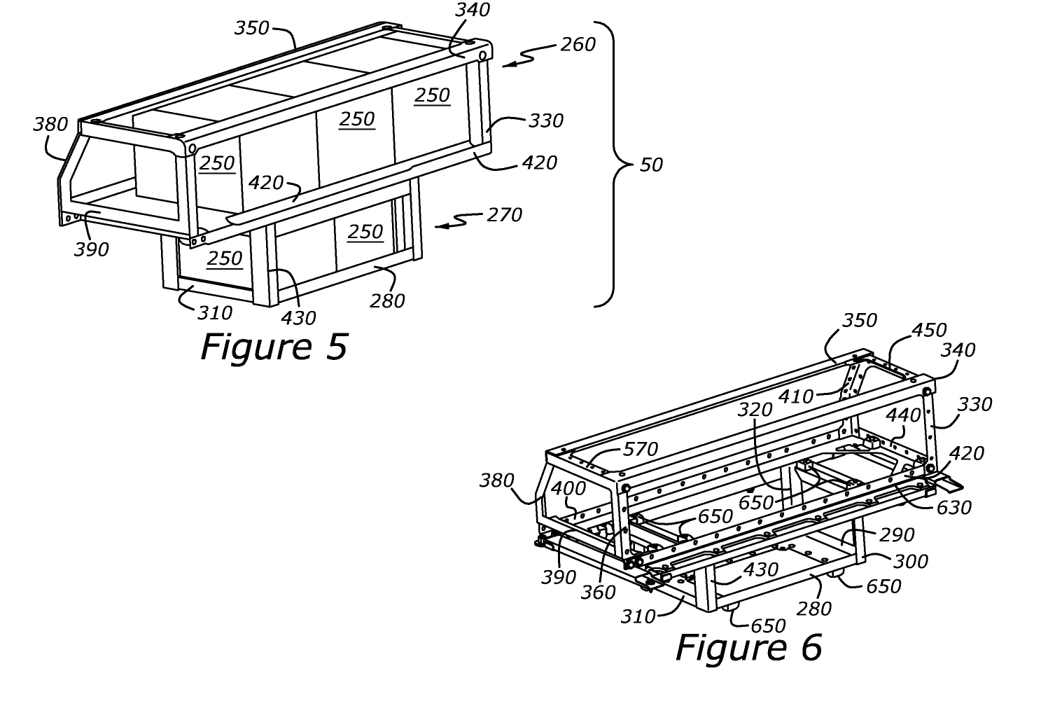

FIG. 5 is a perspective view of the battery pack frame 50 compatible with the pack 30 of FIG. 2, isolated from the vehicle. Frame 50 is configured in a T-shape configuration. Frame 50 houses a set of battery cells sectioned off into five modules 250. The modules 250 define two sections of batteries—an upper section 260 and lower section 270 in this embodiment. Frame 50 defines an upright T-shaped configuration at least because more battery cells and modules are included in the upper section of batteries 260 than the lower section of batteries 270. Sections 260, 270 are of different size, e.g., configuration. Sections 260, 270 can be arranged so that the lower section has more batteries than the upper section. An upside down T-shaped configuration, for example, can be utilized with another version of the frame. In another embodiment, the battery cells are sectioned off into more than two sections. Each section is placed at a different vertical position with respect to the vehicle.

The frame 50—as shown in FIGS. 5 and 6—is composed of a set of rails. Rails 280-450 are L-brackets formed from an extrusion process. Rails 280, 340, 350, 400 and 420 of frame extend laterally across the vehicle (from driver to passenger sides). Rails 300, 320, 330, 360, 380, 410, and 430 of frame extend vertically with respect to the vehicle. Rails 290, 310, 370, 390, 440 and 450 extend longitudinally with respect to the vehicle. The rails 280-450 are composed of steel and are attached via a welding process. In other embodiments, rails can be composed of other metals or polymers—e.g., titanium, aluminum, or hard plastics. Rails 280-450 can be composed of conductive or non-conductive materials. Rails can be affixed using any number of fastening techniques within the art such as soldering, stamping, riveting, screwing, or molding. Rails can also be formed using any number of forming processes including, stamping, milling, molding or extrusion. In one embodiment, rails are pre-stressed so as to deform in a desired direction when a rear impact occurs. For example, rails 390 and 440 can be configured to deform downward when a lateral force is experienced by the frame. In another embodiment, battery pack frame 50 is configured to pivot downward upon rear impact. Front brackets are configured to pivot downward when a longitudinal force is applied.

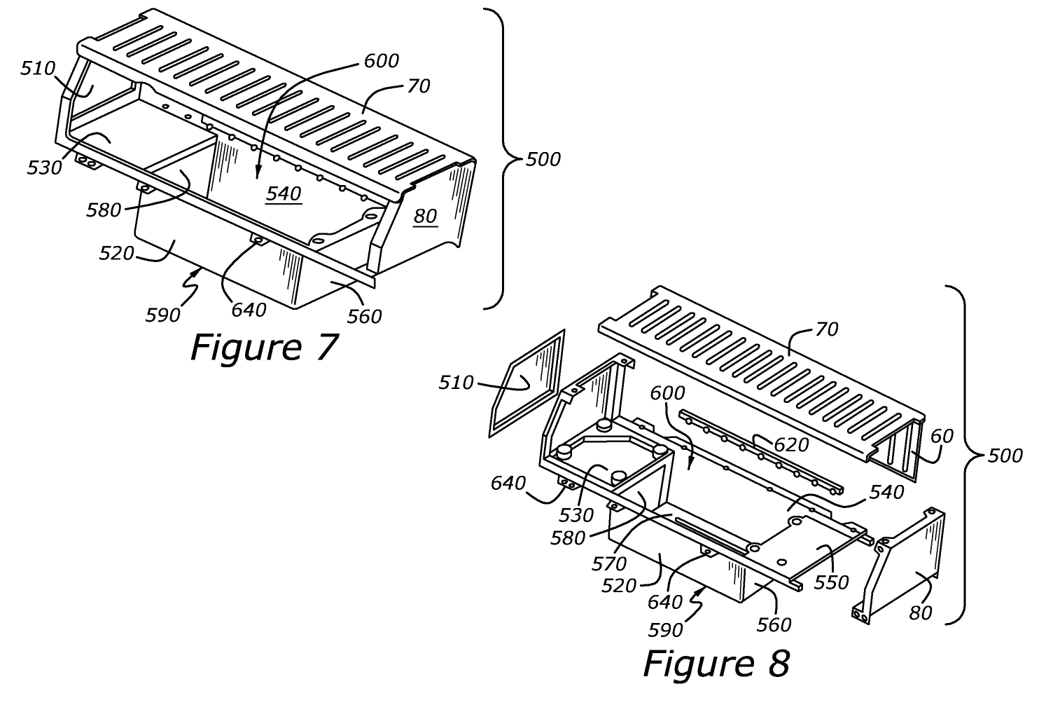

FIGS. 7 and 8, respectively, are a perspective view and exploded view of a frame reinforcement unit 500. Frame reinforcement unit 500 includes panels 60, 70, 80, and 510-580 that are configured to enclose battery modules in the upper and lower sections of the frame. A front panel is removed. Panels 80 and 510 are side panels configured to cover the upper section of battery cells. An L-shaped cover includes panels 60 and 70 which cover the top and rear upper section of the battery pack. Panel 70 is formed with ridges. Reinforcement unit 500 includes a bottom portion 590 having six panels interconnected. The bottom portion 590 defines a well 600 for the lower section of batteries to at least partially fit therein. In this embodiment, bottom portion 600 is formed through a stamping process. In other embodiments, panels of bottom portion 520, 530, 540, 550, 560 and 570 are affixed together through a fastening procedure. Panels 60, 70, 80, and 510-580 can be composed of metals or polymers—e.g., titanium, aluminum, or hard plastics. Panels 60, 70, 80, and 510-580 can be composed of conductive or non-conductive materials. Panels also can be affixed using any number of fastening techniques within the art such as soldering, stamping, riveting, screwing, or molding. In one embodiment, shear panels are reinforced with a crossing set of trusses. In another embodiment shear panels are insulated with material such as foam.

In the illustrated embodiment of FIGS. 7 and 8, panels 60, 70, 80, and 510-580 are interconnected through fasteners, such as the nuts and bolts. A bracket 620 is used to reinforce the attachment between a rear panel 60 of the reinforcement unit and a bottom panel 540. Bracket 620 is secured to panels 60, 540 via screws. Brackets assist in securing the frontward portion of the battery pack to the vehicle floor pan. Brackets 630, as shown in FIG. 8, assist in securing the rearward portion of the battery pack to the vehicle floor pan. Flanges 640 on frame reinforcement unit 500 also serve as direct or indirect attachment points for the pack to the vehicle floor pan. A series of rectangular brackets 650 are incorporated into the reinforcement unit 500. Brackets 650 are configured to enable battery tray attachment to the reinforcement unit. Orifices configured to fit electrical wiring there through, can be formed in any one of the panels. Panels can also be vented to improve heat transfer.

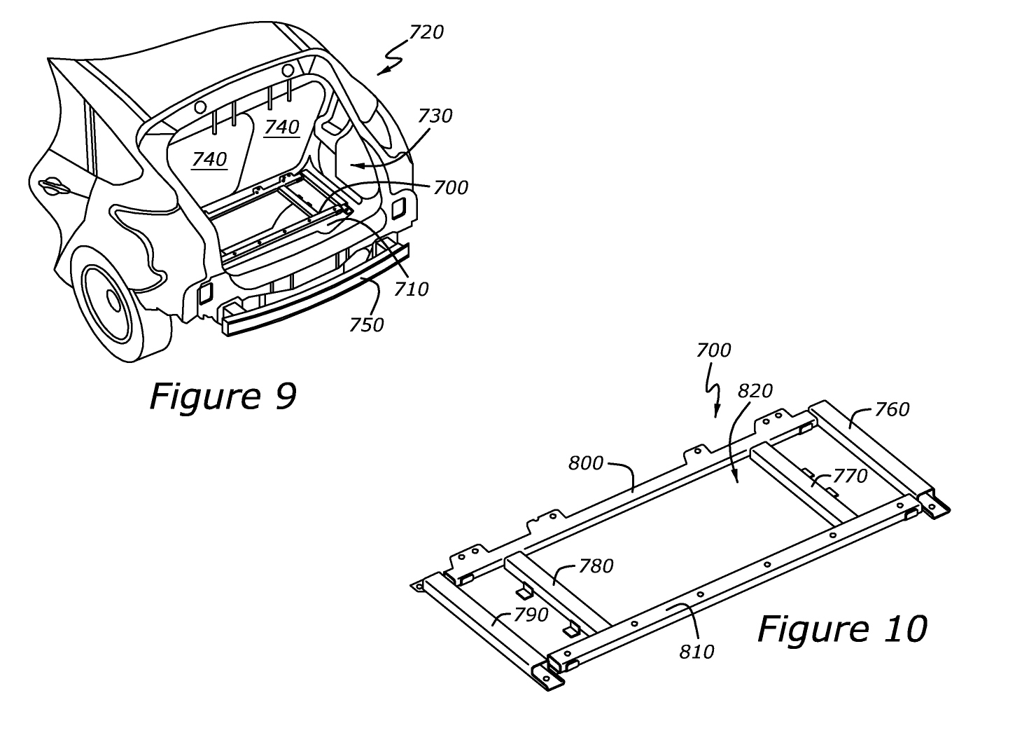

Referring now to FIGS. 9-13, there is shown therein another implementation of a vehicle battery pack with structural reinforcements. The illustrated embodiments teach the use of a reinforcement bracket configured to affix the battery frame to a vehicle structural member. The ladder bracket 700 (or H-brace), as shown in FIG. 9 is attachable to a vehicle floor pan 710 and secures a battery pack to the floor pan.

FIG. 9 is a perspective view of the rear section of a vehicle 720 without a battery pack. An exemplary battery pack can be stored in a rear section of the vehicle 720. The vehicle, as partially shown in FIG. 9, can be any type of vehicle but is a sports utility vehicle. The rear section of the vehicle has a cargo area 730. The rear door is removed. The cargo section 730 of the vehicle is adjacent a rear row of seating 740. A bumper 750 is attached to the vehicle frame and configured to absorb rear impact energy as well.

The ladder bracket 700, as shown in FIG. 10, includes a series of rails arranged so that the upper section of the battery pack can be mounted to the bracket at several locations. The lower section of the battery pack fits through orifice 820. Rails 760, 770, 780 and 790 are configured to extend longitudinally with respect to the vehicle. Rails 800 and 810 are positioned perpendicularly to rails 760, 770, 780 and 790 and are configured to extend laterally with respect to the vehicle. Rails 760-820 are composed of extruded steel. Rails can be composed of metals or polymers—e.g., titanium, aluminum, or hard plastics, including conductive or non-conductive materials. Rails also can be affixed using any number of fastening techniques within the art such as soldering, stamping, riveting, screwing, or molding. Rails are attached together through a welding process. Rails are configured with orifices to enable rails to be secured to the floor pan.

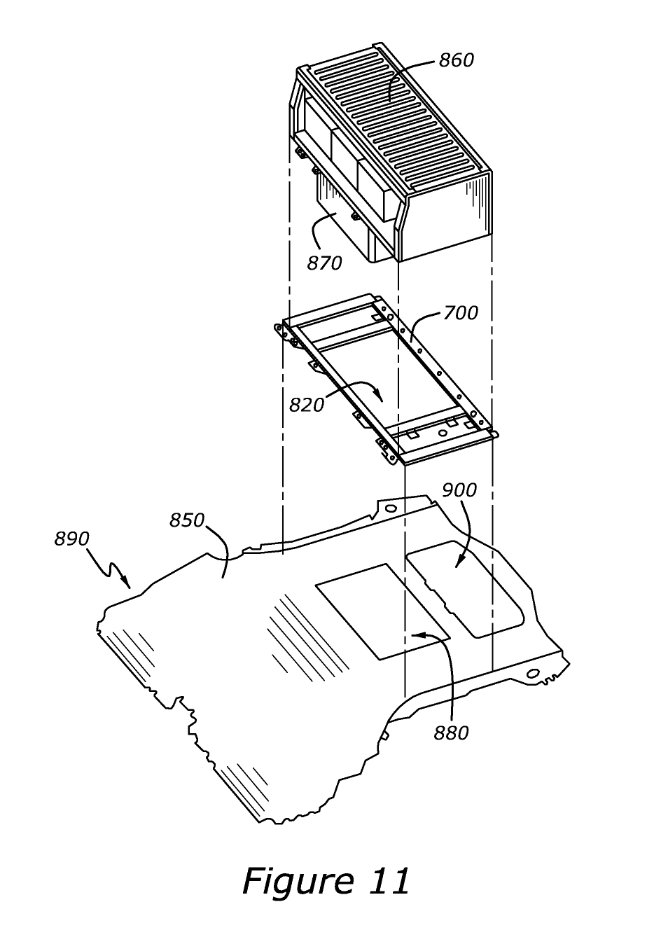

An assembly view of the ladder bracket as implemented on a different vehicle floor pan as shown in FIG. 11. A floor pan 850, the ladder bracket 700 and a battery pack 860 are shown. The lower section of the pack 870 is insertable into orifice 820 defined by bracket 700. The lower portion 870 is also insertable in orifice 880 defined in floor pan 850. The front 890 of the floor pan 850 is angled downward. The floor pan 850 includes an orifice 900 for a storage area. The reinforcement bracket 700 can be an integral part of a vehicle body structure, an integral part of the battery pack structure, or a separate component all together as illustrated.

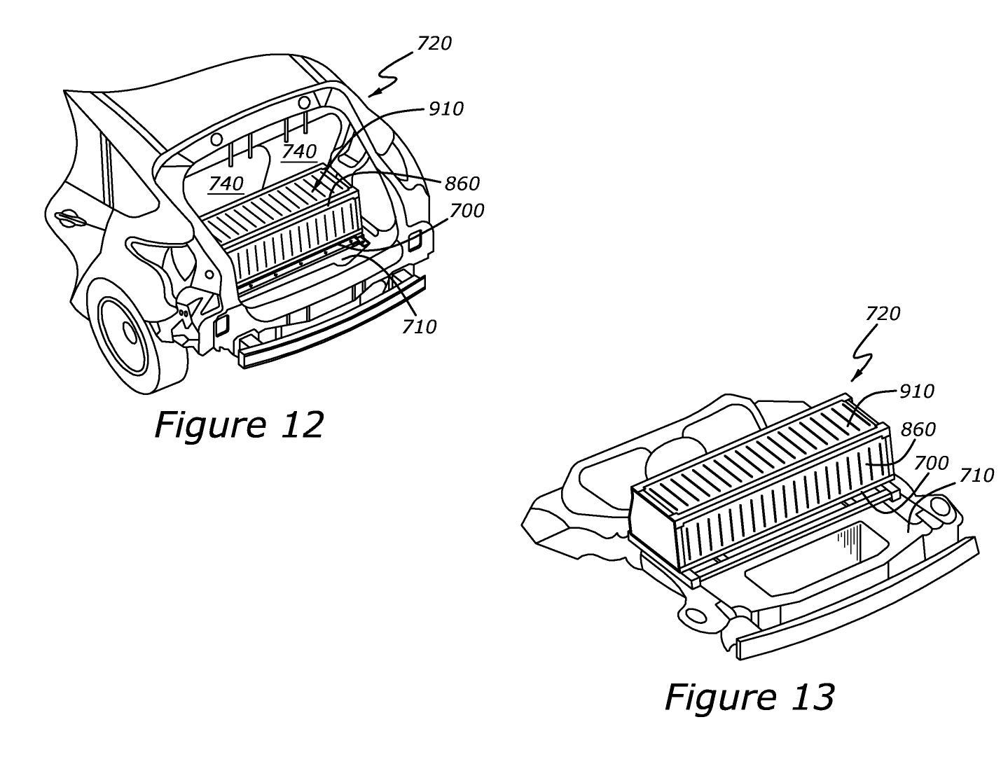

Referring now to FIGS. 12 and 13, which are perspective views of the rear section of vehicle 720 of FIG. 9 with the battery pack 860 included, there is shown the ladder bracket 700 interposed between the battery pack 860 and vehicle floor pan 710. An upper section of the battery pack 910 is partially shown in FIGS. 12-13. The upper section of the battery pack 910 is positioned just behind the lumbar support for the seats 740. The front section of the battery pack is contoured—bent at a 20 degree angle with respect to a vertical axis of the vehicle—to complement the maximum reclined position of the seating lumbar support 740.

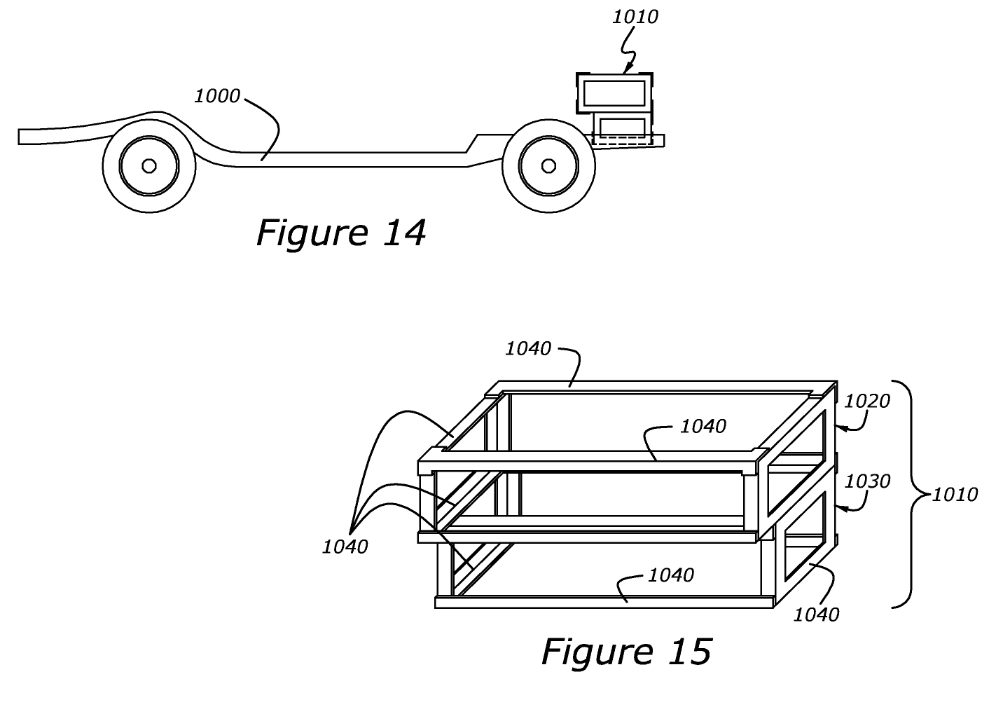

Referring now to FIGS. 14-15 there is shown therein another exemplary battery pack frame for use with a vehicle. FIG. 14 is a side view of a schematic depiction of a vehicle chassis 1000 with an exemplary vehicle battery pack frame 1010. The battery pack frame 1010 is attached to a frontward section of the chassis 1000. The frame 1010 includes a section for housing an upper portion of battery cells 1020 and a lower section of battery cells 1030. In this embodiment, the battery frame is L-shaped. The upper section of the frame 1020 is configured to house more batteries than the lower section 1030.

The frame 1010—as shown in FIG. 15—is composed of a set of rails 1040. Rails 1040 are L-brackets formed from an extrusion process. The rails 1040 are composed of steel and are attached via a welding process. In other embodiments, rails can be composed of other metals or polymers—e.g., titanium, aluminum, or hard plastics. Rails 1040 can be composed of conductive or non-conductive materials. Rails can be affixed using any number of fastening techniques within the art such as soldering, stamping, riveting, screwing, or molding. Rails can also be formed using any number of forming processes including, stamping, milling, molding or extrusion.

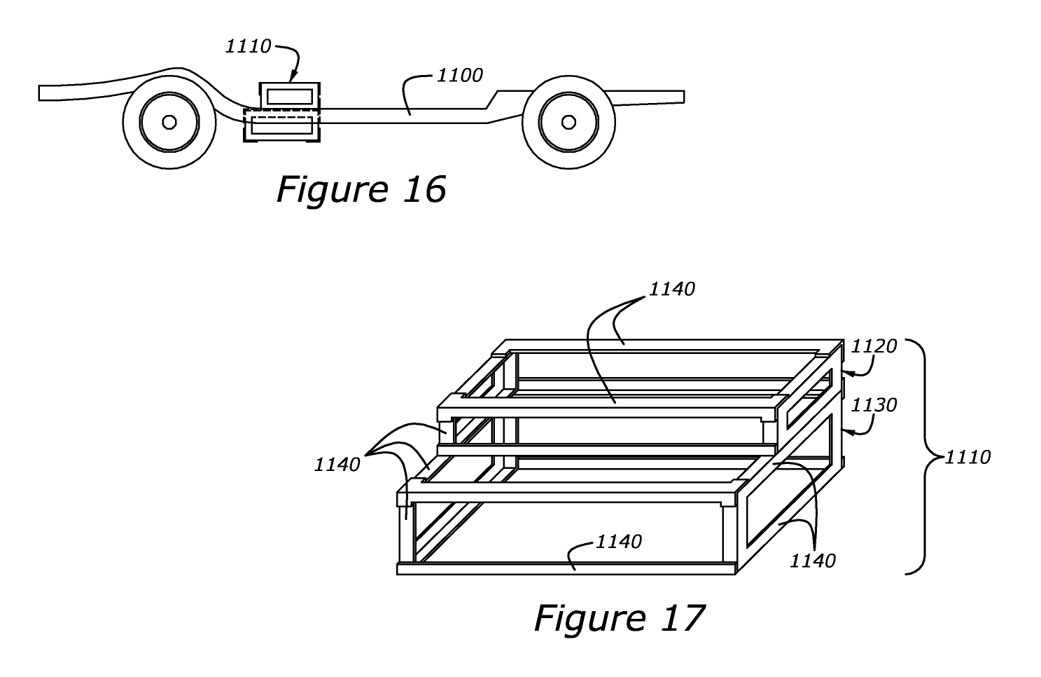

Referring now to FIGS. 16-17 there is shown therein another exemplary battery pack frame for use with a vehicle. FIG. 17 is a side view of a schematic depiction of a vehicle chassis 1100 with an exemplary vehicle battery pack frame 1110. The battery pack frame 1110 is attached to a middle section of the chassis. The frame 1110 includes a section for housing an upper portion of battery cells 1120 and a lower portion of battery cells 1130. In this embodiment, the battery frame 1110 is L-shaped. The upper section of the frame 1120 is configured to house fewer batteries than the lower section 1130.

The frame 1110—as shown in FIG. 17—is composed of a set of rails 1140. Rails 1140 are L-brackets formed from an extrusion process. The rails 1140 are composed of steel and are attached via a welding process. In other embodiments, rails can be composed of other metals or polymers—e.g., titanium, aluminum, or hard plastics. Rails 1140 can be composed of conductive or non-conductive materials. Rails can be affixed using any number of fastening techniques within the art such as soldering, stamping, riveting, screwing, or molding. Rails can also be formed using any number of forming processes including, stamping, milling, molding or extrusion.

A method of manufacturing a battery pack within a vehicle is taught in the present disclosure. The method is applicable to the illustrated embodiments as well as other embodiments of the battery pack. In one embodiment, the steps of the method include: separating a plurality of cells within the module into a first section of cells and a second section of cells, the sections having different configurations (e.g., as shown in FIGS. 2 and 3); forming a frame configured to house at least some of the battery cells; and securing a frame reinforcement unit to the frame. The frame reinforcement unit can include the shear panels, for example, as discussed hereinabove. Frame can be formed by extruding a plurality of L-brackets and welding the brackets together. As shown in the embodiments of FIGS. 2-13, forming the frame can include constructing the frame to define a T-shape configuration.

The method of manufacture also includes: (i) forming a reinforcement bracket securable to the battery pack; and (ii) securing the reinforcement bracket to a vehicle structural member. An exemplary reinforcement bracket is discussed with respect to FIGS. 9-13.

In one embodiment, the method includes contouring the frame to complement a seating section in the vehicle (e.g., with a bend as shown in FIGS. 2-3). Additionally, the method includes positioning an upper section of the frame above a vehicle floor pan; and positioning a lower section below the vehicle floor pan, as shown in the embodiments of FIGS. 2-13.

It will be apparent to those skilled in the art that various modifications and variations can be made to the methodologies of the present invention without departing from the scope of its teachings. Other embodiments of the invention will be apparent to those skilled in the art from consideration of the specification and practice of the teachings disclosed herein. It is intended that the specification and examples be considered as exemplary only.

While the best modes for carrying out the invention have been described in detail, those familiar with the art to which this invention relates will recognize various alternative designs and embodiments for practicing the invention within the scope of the appended claims.

We claim:

1. A battery assembly for a vehicle, comprising:
a plurality of battery cells arranged in sections;
a frame configured to house at least some of the battery cells; and
a frame reinforcement unit securable to the frame.

2. The battery assembly of claim 1, wherein the reinforcement unit includes a plurality of shear resistant panels braced by the frame.

3. The assembly of claim 1, wherein at least two of the sections are of a different configuration.

4. The battery assembly of claim 3, wherein the two sections define an upright T-shaped configuration.

5. The battery assembly of claim 1, further comprising:
a reinforcement bracket configured to affix the battery assembly to a vehicle structural member.

6. The battery assembly of claim 1, wherein a section of the battery frame is contoured to complement a lumbar support for vehicle seating.

7. The battery assembly of claim 1, wherein the frame is composed of steel, titanium, aluminum, magnesium or a plastic.

8. An electrically powered vehicle, comprising:
a battery assembly, including:
a frame, housing at least some battery cells arranged in sections; and
a frame reinforcement unit securable to the frame.

9. The vehicle of claim 8, further comprising:
a vehicle cargo area;
wherein the battery assembly is configured to at least partially fit in the cargo area.

10. The vehicle of claim 9, wherein an upper section of the frame is positioned above a vehicle floor pan and a lower section is positioned below the vehicle floor pan.

11. The vehicle of claim 10, wherein the upper section of the battery frame is contoured.

12. The frame of claim 11, wherein the upper section and the lower section of the frame defines an upright T-shaped configuration.

13. The vehicle of claim 8, further comprising:
a reinforcement bracket affixed to a vehicle structural member and the battery assembly.

14. The battery assembly of claim 8, wherein the frame is composed of steel, titanium, aluminum, magnesium or a plastic.

15. A method of manufacturing a battery pack within a vehicle, comprising:
separating a plurality of cells within the module into a first section of cells and a second section of cells, the sections having different configurations;
forming a frame configured to house at least some of the battery cells; and
securing a frame reinforcement unit to the frame.

16. The method of claim 15, wherein forming the frame includes extruding a plurality of L-brackets and welding the brackets together.

17. The method of claim 16, wherein forming the frame includes constructing the frame to define a T-shape configuration.

18. The method of claim 15, further comprising:
forming a reinforcement bracket securable to the battery pack; and
securing the reinforcement bracket to a vehicle structural member.

19. The method of claim 15, further comprising:
contouring the frame to complement a seating section in the vehicle.

20. The method of claim 15, further comprising:
positioning an upper section of the frame above a vehicle floor pan; and
positioning a lower section below the vehicle floor pan.
